(19) United States
(12) Patent Application Publication
(10) Pub. No.: US 2007/0078987 A1
(43) Pub. Date: Apr. 5, 2007

(54) Multi-mode remote user interface server

(76) Inventors: Mark R. Walker, Beaverton, OR (US); James Edwards, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/244,494

(22) Filed: Sep. 30, 2005

(51) Int. Cl. G06F 15/16

(52) U.S. Cl. 709/227

(57) ABSTRACT

A multi-mode remote user interface server has been presented. In one embodiment, the multi-mode remote user interface server includes a first storage device to store instructions of a remote-capable application, a second storage device coupled to the first storage device to store a graphical interface description language (GIDL) document associated with the remote-capable application, and a processing device coupled to the first storage device and configured to serve remote client devices having different levels of processing capability, the processing device to allow a remote client device to select a mode out of a plurality of modes in which the remote-capable application is to be run. Other embodiments have been claimed and described.

### TECHNICAL FIELD

Embodiments of the invention relate generally to computing systems, and more particularly, to remote user interface servers.

### BACKGROUND

With the rapid advances of digital computing technologies, computing applications are going beyond personal computers (PCs) into every comer of the home to enable home automation. Computing applications in home automation range from lighting control to multimedia entertainment. The PCs may interact with various digital devices over a home area network (HAN) to enable home automation.

A HAN is a network contained within a user's home that couples a user's digital devices to each other wirelessly or via wires. Some examples of the digital devices include PCs, peripheral devices of the PCs (e.g., printers, etc.), telephones, fax machines, televisions, video game systems, home security systems, smart appliances, etc. A current architecture of HANs is Universal Plug and Play (UPNP) standard. UPnP technologies enable automatic configuration and discovery of devices, data transmission over various internet protocols, and communication between different applications and/or devices over a home network.

To appreciate the convenience and richer user experience realized by home automation, consider the following example. A user uses a digital camcorder to take a digital video during a trip. The digital video is then saved onto the user's PC in the study room of the user's home. During a dinner party at the user's home, the user would like to share the digital video with her guests. Instead of having her guests crowded inside her study room to watch the digital video on a monitor connected to her PC, the user may stream the digital video via a home network from her PC to a television in her family room, which is more spacious and more comfortable for her guests. Furthermore, the user may control the streaming of the digital video using remote user interface on the television without going into the study room to operate the PC.

A device coupled to a HAN may be referred to as a home networked device. A remote user interface (RUI) server is a home networked device capable of serving user interfaces to other home networked devices over the HAN. Referring back to the above example, the PC may act as a RUI server to serve remote user interface to the television to allow the user to control streaming of digital video via the television.

A home networked device served by the RUI server is referred to as a remote client device, also known as a remote user interface client. Today, remote client devices may include various electronic devices possessing different levels of processing capability. Examples of remote client devices range from high-end devices (e.g., digital televisions) to low-end devices (e.g., digital media adaptors). A high-end remote client device may include complex processing components to perform various functions, while a low-end remote client device may merely provide simple wireless support to conventional electronic appliances (e.g., a conventional television).

Conventionally, multiple RUI servers, each configured in a particular way to serve remote user interface, are used in to serve remote user interface to remote client devices having different levels of processing capability. Referring back to the above example, the user may have to install at least two RUI servers in the user's HAN if the user has a digital television and a digital media adaptor coupled to the HAN, where one of the RUI servers is dedicated to serving remote user interface to the digital television and the other RUI server is dedicated to serving remote user interface to the digital media adaptor. Having multiple RUI servers on a HAN increases the complexity as well as the overall cost of the network.

### BRIEF DESCRIPTION OF THE DRAWINGS

Embodiments of the present invention is illustrated by way of example and not limitation in the figures of the accompanying drawings, in which like references indicate similar elements and in which:

FIG. 1 shows one embodiment of a home computing network;

FIGS. 2A-2C show one embodiment of a process to establish a remote user interface server session to run a remote-capable application;

FIG. 3 shows one embodiment of a multi-mode remote user interface server; and

FIG. 4 shows an exemplary embodiment of a personal computer usable to implement a multi-mode remote user interface server.

### DETAILED DESCRIPTION

A multi-mode remote user interface server is disclosed. In the following detailed description, numerous specific details are set forth in order to provide a thorough understanding. However, it will be apparent to one of ordinary skill in the art that these specific details need not be used to practice some embodiments of the present invention. In other circumstances, well-known structures, materials, circuits, processes, and interfaces have not been shown or described in detail in order not to unnecessarily obscure the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

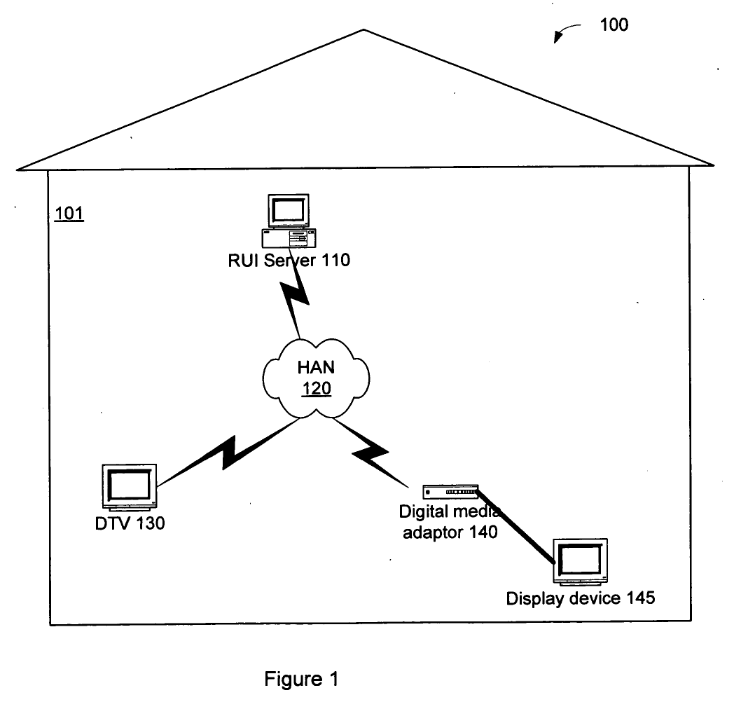

FIG. 1 shows one embodiment of a home computing networked system within a home 101. The system 100 includes a remote user interface (RUI) server 110, a home area network (HAN) 120, and a number of remote client devices. Examples of the remote client devices shown in FIG. 1 include a digital television (TV) 130, a digital media adaptor 140, and a display monitor 145. The HAN 120 may include a Universal Plug-and-Play (UPNP) network. In the current description, a RUI server is a networked device capable of serving user interfaces to other display and client devices over a home network, such as the HAN 120. A remote client device, also known as a remote user interface client, is a networked device coupled to a home network and served by a RUI server.

In some embodiments, some or all of the remote client devices possess a fully functional, local user interface of their own and may not need a RUI except for providing additional experiences to users. These RUI client devices may be referred to as autonomous RUI clients. Alternatively, some or all of the remote client devices do not possess a local user interface and are dependent on other devices on the HAN 120 (e.g., the RUI server 110) to provide user interfaces. These remote client devices are also known as fully remoted RUI clients.

Note that any or all of the components and the associated hardware illustrated in FIG. 1 may be used in various embodiments of the system 100. However, it should be appreciated that other configurations of the system may include more or less devices than those shown in FIG. 1.

In one embodiment, the RUI server 110, the digital TV 130, and the digital media adaptor 140 are coupled to the HAN 120. The digital media adaptor 140 is further coupled to a display device 145, which may be a monitor, a conventional television, etc. Note that some or all of the above components may be coupled to each other wirelessly or via wires. For instance, the digital media adaptor 140, the digital TV 130, and the RUI server 110 may be wirelessly coupled to the HAN 120, while the display device 145 may be coupled to the digital media adaptor 140 via audio and video cables. Furthermore, some or all of the above components may be located at the same location or at different locations within the home.

As mentioned above, the digital media adaptor 140 and the digital TV 130 are examples of remote client devices served by the RUI server 110. One should appreciate that the RUI server 110 may serve other remote client devices in different embodiments. Note that the digital TV 130 and the digital media adaptor 140 have different levels of processing capability. In some embodiments, the RUI server 110 is configured to provide two modes to run a remote-capable application (RCA) in order to support these remote client devices having different levels of processing capability. In the current description, a RCA is a computing application that may be run by a server partially or entirely on a remote client device. Thus, the RUI server 110 may be referred to as a multi-mode RUI server.

In one embodiment, the RUI server 110 provides a first mode to support remote client devices having a lower level of processing capability, such as the digital media adaptor 140. When the digital media adaptor 140 has chosen the first mode, the RUI server 110 generates a binary image (e.g., a pixel bitmap, a JPEG file, etc.) based upon a graphical interface description language (GIDL) document associated with the RCA. The GIDL document may be stored in the RUI server 110. Examples of GIDL include hypertext markup language (HTML), extended HTML (XHTML), etc. The binary image is then sent over the HAN 120 to the digital media adaptor 140, which causes the binary image to be displayed on the display device 145. Then a user may perform certain action in response to the binary image displayed. For instance, the binary image displayed may include a list of objects (e.g., a “NEXT” button to advance to the next stage of an application, an “ABORT” button to abort the application, etc.). The user may click on one of the objects at a predetermined location on the binary image displayed to indicate what the user wants to do.

Mechanical description of the user action may be sent from the digital media adaptor 140 via the HAN 120 to the RUI server 110. For example, mechanical description of mouse click at location (X,Y) is sent to the RUI server 110 when the user clicks on the “NEXT” button at location (X,Y) on the binary image displayed. The RUI server 110 interprets the mechanical description to determine what the user wants and runs the RCA in response to the user action. The RUI server 110 may then generate another binary image in response to the user action, which is to be sent to the digital media adaptor 140 to refresh the image displayed on the display device 145.

In addition to the first mode, the RUI server 110 provides a second mode to run the RCA on remote client devices with a higher level of processing capability, such as the digital TV 130. In one embodiment, the GIDL document is pulled from the RUI server 110 to the digital TV 130 after the digital TV 130 has selected the second mode. Hypertext Transfer Protocol (HTTP) may be used to pull GIDL documents from the RUI server 110 to the digital TV 130. User action with respect to a binary image rendered based upon the GIDL document pulled are processed by the digital TV 130 to output data of user-initiated events (e.g., mouse click events, key press events, etc.). The digital TV 130 then conveys the data of the user-initiated events to the RUI server 110 using a common web protocol. One example of the common web protocol is document object model (DOM), which is used to represent the events that result from a user acting on a rendered XHTML document.

In one embodiment, the user-initiated events are conveyed from the digital TV 130 back to the RUI server 110, where the events are translated into information by an event processor of the RUI server 110. The event processor may communicate with the RCA being controlled and or utilized on the digital TV 130. In response to the user-initiated events, the RUI server 110 may cause the digital TV 130 to locally generate an updated version of the binary image subsequently.

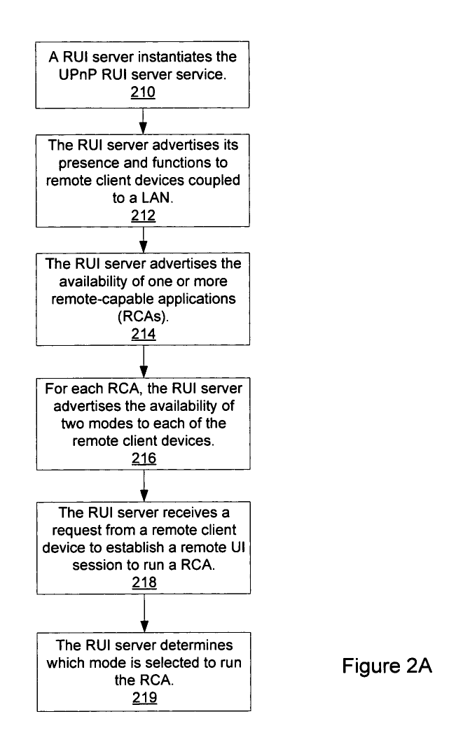

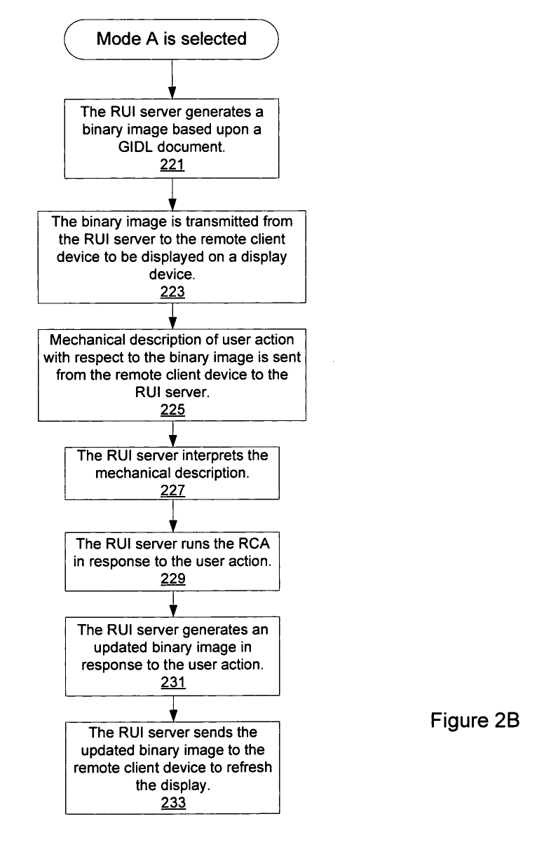

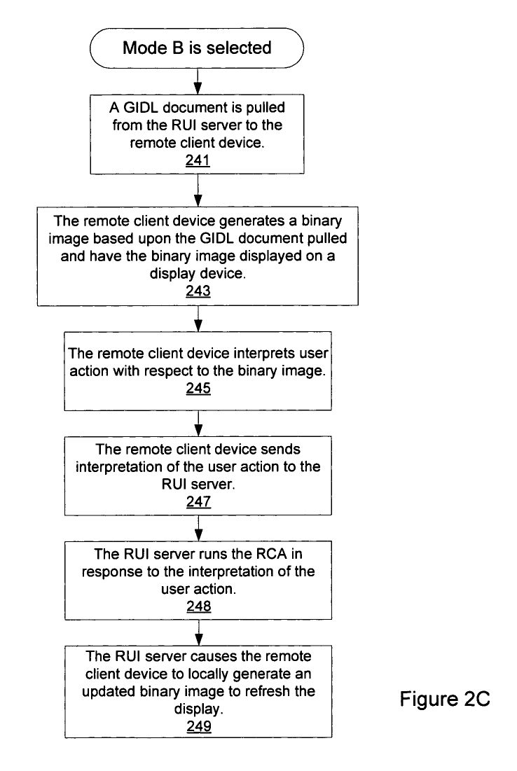

One embodiment of a process to setup and configure a remote UI session on a multi-mode RUI server is described in details below with reference to FIGS. 2A-2C. The process may be performed by processing logic that may comprise hardware (e.g., circuitry, dedicated logic, etc.), software (such as a program operable to run on a general-purpose computer system or a dedicated machine), or a combination of both.

Referring to FIG. 2A, a RUI server instantiates RUI service, such as UPNP RUI service (processing block 210). Then the RUI server advertises its presence and functions to remote client devices coupled to the RUI server via a local area network (such as the HAN 120 in FIG. 1) (processing block 212). In some embodiments, the RUI server supports a number of remote-capable applications (RCAs) and the RUI server advertises the availability of the RCAs to the remote client devices (processing block 214). For each RCA, the RUI server advertises the availability of two modes to the remote client devices (processing block 216). The two modes are referred to as mode A and mode B hereinafter.

In some embodiments, a remote client device coupled to the RUI server via the local area network locates the RUI server and the advertised RCAs. The remote client device proceeds to select one of the modes for establishing a remote UI session with the RUI server. The remote client device may select a mode based on the level of processing capability of the remote client device. If the remote client device has a relatively low level of processing capability, like the digital media adaptor 140 in FIG. 1, then the remote client device may select mode A. If the remote client device has a high level of processing capability, like the digital TV 130 in FIG. 1, such that the remote client device can render binary images from GIDL documents by itself, the remote client device may select mode B.

In processing block 218, the remote client device submits a request to the RUI server to establish a remote user interface (UI) session to run a RCA in one of the modes advertised. In one embodiment, string matching may be used to select a mode. For example, a string “XRT” may be used to select mode A and a string “XHTML-DOM” may be used to select mode B. Based on the remote client device's mode selection, the RUI server configures a UI session in the selected mode.

If mode A is selected, the process continues in FIG. 2B. Referring to FIG. 2B, the RUI server generates a binary image based upon a GIDL document associated with the RCA being run (processing block 221). Then binary image is transmitted from the RUI server to the remote client device to be displayed on a display device, such as the display device 145 in FIG. 1 (processing block 223). Mechanical description of user action with respect to the binary image is sent from the remote client device to the RUI server (processing block 225). The RUI server interprets the mechanical description of the user action (processing block 227). Then the RUI server runs the RCA in response to the interpretation of the mechanical description of the user action (processing block 229). In some cases, the RUI server generates an updated binary image in response to the user action (processing block 231). The RUI server may send the updated binary image to the remote client device to refresh the display (processing block 233).

Alternatively, if the remote client device selects mode B, the process illustrated in FIG. 2C is performed. Referring to FIG. 2C, a GIDL document associated with the RCA being run is pulled from the RUI server to the remote client device (processing block 241). The remote client device generates a binary image based upon the GIDL document pulled and have the binary image displayed on display device, such as the screen of the digital TV 130 (processing block 243). The remote client device processes user action with respect to the binary image to output data of user-initiated events (processing block 245) and sends the data to the RUI server (processing block 247). The RUI server runs the RCA in response to the user-initiated events (processing block 248). The RUI server may cause the remote client device to locally generate an updated binary image to refresh the display (processing block 249).

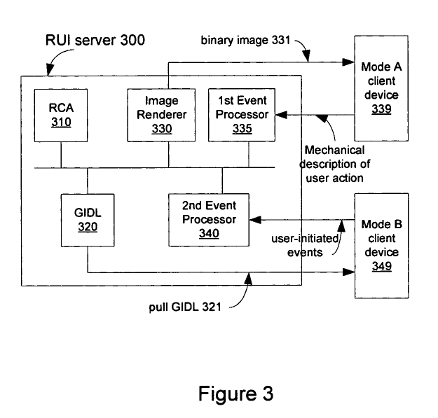

FIG. 3 shows one embodiment of a multi-mode remote user interface (RUI) server. The RUI server 300 includes a first storage device 310, a second storage device 320, an image renderer 330, a first event processor 335, and a second event processor 340, which are coupled to each other. The RUI server 300 may be further coupled to a mode A client device 339 and a mode B client device 349.

In one embodiment, the first storage device 310 stores instructions of at least one remote-capable application (RCA). The second storage device 320 stores a graphical interface description language (GIDL) document associated with the RCA. The RUI server 300 is configured to serve remote client devices having different levels of processing capability, such as the mode A client device 339 and the mode B client device 349. In the current example, the mode A client device 339 has a lower level of processing capability than the mode B client device 349.

When the mode A client device 339 establishes a RUI session with the RUI server 300, the image renderer 330 retrieves the GIDL document from the second storage device 320 and generates a binary image based upon the GIDL document. The binary image is delivered to the mode A client device 339 to be displayed on a display device. Furthermore, the first event processor 335 interprets mechanical description of user action with respect to the binary image from the mode A client device 339. Based on the interpretation of the mechanical description of user action, the RUI server 300 runs the RCA accordingly. The image renderer 330 may generate an updated binary image to be sent to the mode A client device 339 to refresh the display.

When the mode B client device 349 establishes a RUI session with the RUI server 300, the mode B client device 349 pulls the GIDL document from the second storage device 320 and renders a binary image from the GIDL document to display to a user. The user may perform action with respect to the binary image to initiate one or more events. With its higher level of processing capability, the mode B client device 349 may process user action to output user-initiated events to the RUI server 300. The second event processor 340 may translate the user-initiated events into information to be used in running the RCA. In some embodiments, the RUI server 300 may cause the mode B client device 349 to locally generate an updated binary image to refresh the display.

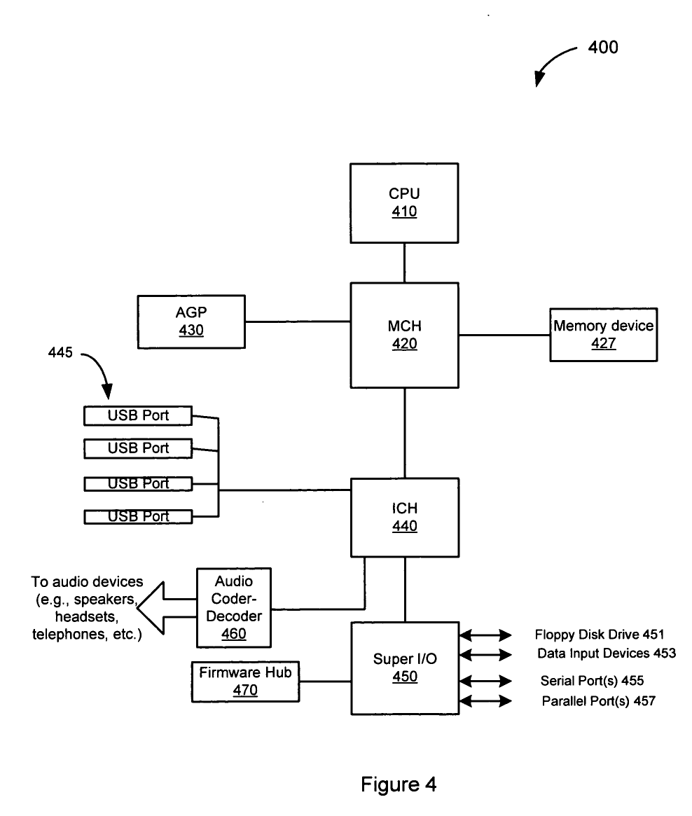

In some embodiments, the RUI server 300 may be implemented using a personal computer. FIG. 4 shows an exemplary embodiment of a personal computer usable to implement some embodiments of a multi-mode RUI server. The personal computer 400 includes a central processing unit (CPU) 410, a memory controller (MCH) 420, a memory device 427, a graphic port (AGP) 430, an input/output controller (ICH) 440, a number of network interfaces (such as Universal Serial Bus (USB) ports 445, Super Input/Output (Super I/O) 450, etc.) an audio coder-decoder 460, and a firmware hub (FWH) 470.

In one embodiment, the CPU 410, the graphic port 430, the memory device 427, and the ICH 440 are coupled to the MCH 420. The MCH 420 routes data to and from the memory device 427. Note that the MCH 420 may or may not be integrated with the CPU 410. In some embodiments, the CPU 410 and the MCH 420 reside on the same integrated circuit substrate. Alternatively, the CPU 410 and the MCH 420 reside on different integrated circuit substrates. The memory device 427 may include various types of memories, such as, for example, dynamic random access memory (DRAM), synchronous dynamic random access memory (SDRAM), double data rate (DDR) SDRAM, etc. In one embodiment, the USB ports 445, the audio coder-decoder 460, and the Super I/O 450 are coupled to the ICH 440. The Super I/O 450 may be further coupled to a firmware hub 470, a floppy disk drive 451, data input devices 453 (e.g., a keyboard, a mouse, etc.), a number of serial ports 455, and a number of parallel ports 457. The audio coder-decoder 460 may be coupled to various audio devices, such as speakers, headsets, telephones, etc.

Note that any or all of the components and the associated hardware illustrated in FIG. 4 may be used in various embodiments of the personal computer 400. However, it should be appreciated that other configurations of the personal computer may include one or more additional devices not shown in FIG. 4. Furthermore, one should appreciate that the technique disclosed is applicable to different types of system environment, such as a multi-drop environment or a point-to-point environment. Likewise, the disclosed technique is applicable to both mobile and desktop computing systems.

Some portions of the preceding detailed description have been presented in terms of symbolic representations of operations on data bits within a computer memory. These descriptions and representations are the tools used by those skilled in the data processing arts to most effectively convey the substance of their work to others skilled in the art. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations described herein. This apparatus may be specially constructed for the required purposes, or it may comprise a general-purpose computer selectively activated or reconfigured by a computer program stored in the computer. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, embodiments of the present invention are not described with reference to any particular programming language. It will be appreciated that a variety of programming languages may be used to implement the teachings as described herein.

The foregoing discussion merely describes some exemplary embodiments of the present invention. One skilled in the art will readily recognize from such discussion, the accompanying drawings and the claims that various modifications can be made without departing from the spirit and scope of the subject matter.

What is claimed is:

1. A method comprising:
allowing a remote client device to select a mode out of a plurality of modes to run a remote-capable application associated with a graphical interface description language (GIDL) document using a remote user interface server configured to serve remote client devices having different levels of processing capability; and
establishing a remote session between the remote user interface server and the remote client device to run the remote-capable application in the mode selected in response to a request submitted by the remote client device.

2. The method of claim 1, wherein, if the remote client device selects a first mode, the method further comprises:
generating a binary image from the GIDL document using the remote user interface server; and
sending the binary image from the remote user interface server to the remote client device to be displayed on a display device.

3. The method of claim 2, wherein, if the remote client device selects the first mode, the method further comprises:
receiving mechanical description of user action with respect to the binary image at the remote user interface server from the remote client device;
interpreting the mechanical description using the remote user interface server; and
running the remote-capable application on the remote user interface server in response to the user action.

4. The method of claim 3, wherein, if the remote client device selects the first mode, the method further comprises:
generating an updated binary image in response to the user action; and
sending the updated binary image from the remote user interface server to the remote client device to refresh a display on the display device.

5. The method of claim 1, wherein, if the remote client device selects a second mode, the method further comprises:
allowing the remote client device to pull the GIDL document from the remote user interface server, wherein the remote client device locally generates from the GIDL document a binary image to be displayed on a display device.

6. The method of claim 5, wherein, if the remote client device selects the second mode, the method further comprises:
running the remote-capable application on the remote user interface server in response to one or more user-initiated events, wherein the remote client device processes user action to output data of the user-initiated events to the remote user interface server; and
causing the remote client device to locally generate an updated binary image to refresh a display on the display device.

7. A machine-accessible medium that provides instructions that, if executed by a processor, will cause the processor to perform operations comprising:
allowing a remote client device to select a mode out of a plurality of modes to run a remote-capable application associated with a graphical interface description language (GIDL) document using a remote user interface server configured to serve remote client devices having different levels of processing capability; and
establishing a remote session between the remote user interface server and the remote client device to run the remote-capable application in the mode selected in response to a request submitted by the remote client device.

8. The machine-accessible medium of claim 7, wherein if the remote client device selects a first mode, the operations further comprise:
generating a binary image from the GIDL document using the remote user interface server; and
sending the binary image from the remote user interface server to the remote client device to be displayed on a display device.

9. The machine-accessible medium of claim 8, wherein if the remote client device selects the first mode, the operations further comprise: receiving mechanical description of user action with respect to the binary image at the remote user interface server from the remote client device;
interpreting the mechanical description using the remote user interface server; and
running the remote-capable application on the remote user interface server in response to the user action.

10. The machine-accessible medium of claim 9, wherein if the remote client device selects the first mode, the operations further comprise:
generating an updated binary image in response to the user action; and
sending the updated binary image from the remote user interface server to the remote client device to refresh a display on the display device.

11. The machine-accessible medium of claim 7, wherein if the remote client device selects a second mode, the operations further comprise:
allowing the remote client device to pull the GIDL document from the remote user interface server, wherein the remote client device locally generates from the GIDL document a binary image to be displayed on a display device.

12. The machine-accessible medium of claim 11, wherein if the remote client device selects the second mode, the operations further comprise:
running the remote-capable application on the remote user interface server in response to one or more user-initiated events, wherein the remote client device processes user action to output data of the user-initiated events to the remote user interface server; and
causing the remote client device to locally generate an updated binary image to refresh a display on the display device.

13. An apparatus comprising:
a first storage device to store instructions of at least one remote-capable application;
a second storage device coupled to the first storage device to store at least one graphical interface description language (GIDL) document associated with the remote-capable application; and
a processing device coupled to the first storage device and configured to serve remote client devices having different levels of processing capability, the processing device to allow a remote client device to select a mode out of a plurality of modes in which the remote-capable application is to be run.

14. The apparatus of claim 13, further comprising:
an image renderer coupled to the second storage device to retrieve the GIDL document from the second storage device and to generate a binary image based upon the GIDL document if the remote client device selects a first mode, the binary image to be delivered to the remote client device to be displayed on a display device; and
a first event processor coupled to the second storage device to interpret mechanical description of user action with respect to the binary image from the remote client device if the remote client device selects the first mode.

15. The apparatus of claim 13, further comprising:
a second event processor coupled to the second storage device to receive data of user-initiated events from the remote client device and to run the remote-capable application in response to the user-initiated events if the remote client device selects a second mode.

16. A system comprising:
a home area network (HAN);
a remote client device coupled to the HAN; and
a remote user interface server coupled to the HAN, the remote user interface. server including
a first storage device to store instructions of at least one remote-capable application;
a second storage device coupled to the first storage device to store at least one graphical interface description language (GIDL) document associated with the remote-capable application, and
a processing device coupled to the first storage device and configured to serve remote client devices having different levels of processing capability, the processing device to allow a remote client device to select a mode out of a plurality of modes in which the remote-capable application is to be run.

17. The system of claim 16, wherein the remote client device comprises a digital television.

18. The system of claim 16, wherein the remote client device comprises a digital media adaptor.

19. The system of claim 16, wherein the remote user interface server comprises a personal computer.
